(19) United States
(12) Patent Application Publication
(10) Pub. No.: US 2025/0015264 A1
(43) Pub. Date: Jan. 9, 2025

(54) CATALYST-EMBEDDED MESOPOROUS CARBON CRYOGELS FOR ENERGY STORAGE

(71) Applicant: XBM USA LLC, Sheridan, WY (US)

(72) Inventor: Junbing Yang, Placentia, CA (US)

(73) Assignee: XBM USA LLC, Sheridan, WY (US)

(21) Appl. No.: 18/765,798

(22) Filed: Jul. 8, 2024

Related U.S. Application Data
(60) Provisional application No. 63/525,213, filed on Jul. 6, 2023.

(51) Int. Cl. H01M 4/36; B01J 23/02; B01J 23/745; B01J 23/755; B01J 27/138; B01J 27/232; B01J 31/02; B82Y 30/00; C01B 32/318; C01B 32/336; H01M 4/02; H01M 4/133; H01M 4/48; H01M 4/587; H01M 10/052

(52) U.S. Cl. CPC H01M 4/364; B01J 23/02; B01J 23/745; B01J 23/755; B01J 27/138; B01J 27/232; B01J 31/0204; B01J 31/0279; C01B 32/318; C01B 32/336; H01M 4/133; H01M 4/48; H01M 4/587; H01M 10/052; B82Y 30/00; C01P 2006/12; C01P 2006/16; C01P 2006/40; H01M 2004/021; H01M 2004/028

(57) ABSTRACT

A method for fabricating carbon cryogel exhibiting high surface area, an increased mesopore ratio, and cost-efficiency, utilizing biomass-derived, low-cost tannin and formaldehyde. Furthermore, this method incorporates calcium salt as a catalyst, a deviation from the widely used sodium carbonate. The resulting carbon cryogel possesses high surface area, an enhanced mesopore ratio, and improved sulfur loading capacity, rendering them ideal sulfur hosts for Li—S batteries. The present method disclosed herein constitutes a significant improvement over the existing state-of-the-art carbon cryogel for Li—S batteries, with potential implications for the progression of high-performance, cost-effective Li—S batteries.

### CROSS REFERENCE TO RELATED APPLICATIONS

The present application claims the priority benefit of U.S. provisional patent application 63/525,213, filed on Jul. 6, 2023, titled “Catalyst-Embedded Mesoporous Carbon Cryogels for Energy Storage,” the disclosure of which is incorporated herein by reference.

### BACKGROUND

Lithium-sulfur (Li—S) batteries have gained considerable attention as a promising energy storage technology due to their high theoretical energy density, low cost, and abundance of sulfur. In Li—S batteries, electrochemical reactions occur between lithium and sulfur, where sulfur serves as the active material in the cathode. However, the practical application of Li—S batteries faces several challenges that limit their performance and commercial viability.

One of the major issues with Li—S batteries is the dissolution and migration of intermediate lithium polysulfide species (Li₂Sₓ, where x is typically between 4 and 8) during cycling, commonly referred to as the lithium polysulfide shuttle phenomenon. These highly soluble lithium polysulfides can diffuse through the electrolyte and reach the lithium anode, resulting in capacity loss, poor cycling stability, and rapid degradation of the battery performance over repeated charge-discharge cycles.

Various approaches have been explored to mitigate the lithium polysulfide shuttle and improve the performance of Li—S batteries. One promising strategy involves the use of carbon materials as hosts for sulfur, aiming to confine the sulfur species and prevent their dissolution and migration. Carbon materials, such as carbon aerogels and carbon cryogels, offer high surface area, porosity, and electrical conductivity, making them suitable candidates for sulfur encapsulation in Li—S batteries.

Resorcinol-formaldehyde (RF) carbon cryogel have been widely investigated as hosts for sulfur in Li—S batteries. The cryogel are typically synthesized through the sol-gel process using resorcinol and formaldehyde as precursors, followed by aging, freeze drying, and carbonization. RF carbon cryogel provides a three-dimensional porous structure with a high surface area, enabling efficient sulfur loading and accommodating the volume expansion of sulfur during cycling. However, the RF system is expensive and limits the scalability of the process, thus necessitating the development of alternative methods to produce carbon cryogel.

Doping nanoparticles such as metal, metal oxide, sulfide and nitride into porous carbon has been proven to be an effective strategy for mitigating the lithium polysulfide shuttle phenomenon in lithium-sulfur (Li—S) batteries. The presence of these catalyst nanoparticles within the carbon host materials enhances the electrochemical reactions and prevents the migration of lithium polysulfides, thereby improving battery performance.

However, it is important to ensure a uniform distribution of the catalyst nanoparticles throughout the carbon structure to maximize their catalytic effect. Traditional methods of catalyst loading onto porous carbon often result in non-uniform distribution, leading to sub-optimal catalyst utilization and performance degradation. Achieving a uniform catalyst distribution within the carbon host materials is crucial to fully leverage their catalytic capabilities and effectively mitigate the lithium polysulfide shuttle.

Typical approaches for catalyst loading onto porous carbon often result in non-uniform distribution, leading to sub-optimal catalyst utilization and performance degradation. Achieving a uniform catalyst distribution throughout the carbon structure is crucial to maximize the catalytic effect on the electrochemical reactions and mitigate the lithium polysulfide shuttle.

### SUMMARY

The present technology produces catalyst-embedded mesoporous carbon cryogels with improved porosity and sulfur loading capacity for lithium-sulfur batteries. The carbon cryogels can be fabricated using biomass-derived precursors, a crosslinking agent, a catalyst, a surfactant, and a solvent. The catalyst undergoes conversion into metal nanoparticles and serves as a carbon gasification catalyst during the activation process, resulting in the creation of large mesopores around them in the carbon cryogels. The resulting carbon cryogels exhibit high surface area, well-defined pore structure, and a uniform distribution of embedded catalyst nanoparticles. These materials address the limitations of Li—S batteries, offering enhanced battery performance and applications in energy storage systems.

In some instances, the present technology implements a method for producing a catalyst-embedded mesoporous carbon cryogel. The method begins with preparing a sol-gel solution that includes a biomass-derived polyphenolic precursor, a crosslinking agent, a catalyst, and a surfactant in a solvent. The sol-gel solution is then aged to form a gel. The gel is then frozen to form an organic cryogel. The organic cryogel is then carbonized in the presence of an inert gas to prepare a carbon cryogel having a first number of mesopores. The carbonized cryogel is then activated in the presence of an oxidative gas to prepare an activated carbon cryogel having a second number of mesopores in the carbon cryogel, wherein the second number of mesopores for the activated carbon cryogel is larger than the first number of mesopores in the carbonized cryogel.

In some instances, the present technology includes a carbon cryogel for use as a sulfur host material. The carbon cryogel includes a porous carbon material and plurality of catalyst nanoparticles. The porous carbon material is frozen to form an activated carbon cryogel. The plurality of catalyst nanoparticles are uniformly embedded within the activated carbon cryogel and distributed within the activated carbon cryogel.

In some instances, the present technology includes a battery cell. The batter cell includes a cathode electrode, an anode electrode, a separator, an electrolyte, and a housing that contains the electrodes, separator and the electrolyte. The cathode electrode material includes a sulfur cathode that includes a host material, wherein the host material formed from a catalyst-embedded mesoporous carbon cryogel.

### BRIEF DESCRIPTION OF FIGURES

FIG. 1 is a method for preparing host materials.

FIG. 2 illustrates a method for fabricating a carbon cryogel host material for sulfur in Li—S batteries.

FIG. 3 illustrates a method for forming a sol-gel.

FIG. 4 illustrates a method for fabricating Catalyst-Embedded Mesoporous Carbon Cryogel as sulfur host materials for lithium-sulfur (Li—S) batteries.

FIG. 5 illustrates a method 500 for fabricating a nickel oxide embedded mesopourous carbon cryogel.

FIG. 6 illustrates a method for fabricating a host material.

FIG. 7 illustrates a method for preparing a tannin-formaldehyde gel using calcium nitrate as a catalyst and co-solvent of distilled water, methanol and acetone.

FIG. 8 illustrates a method 800 for preparing the tannin-formaldehyde gel using a nickel nitrate catalyst and subjecting the gel to an acid wash.

FIG. 9 illustrates a method for preparing a boron-nitrogen co-doped mesoporous carbon cryogel.

FIG. 10 illustrates a method 1000 for preparing a cryogel with carbon nano-tubes.

FIG. 11 illustrates a method for preparing a cryogel with graphene.

FIG. 12 illustrates a method 1200 for preparing an ultrasound assisted carbon cryogel.

FIG. 13 illustrates a method 1300 for forming a sol-gel using microwave irradiation.

FIG. 14 illustrates a method 1400 for forming a composite of sulfur with a cryogel host within a pouch.

FIG. 15 illustrates a method 1500 for providing an improved carbon cryogel.

FIG. 16 illustrates an SEM image of metal oxide doped mesoporous carbon.

FIG. 17 illustrates a TEM image of metal oxide doped mesoporous carbon.

FIG. 18 illustrates a battery cell.

### DETAILED DESCRIPTION

Lithium-sulfur (Li—S) batteries have attracted substantial interest as a promising alternative to conventional lithium-ion batteries due to their high theoretical energy density. However, the practical implementation of Li—S batteries is hindered by several challenges, predominantly the low cycling stability and limited capacity of the sulfur cathode. Carbon materials, with a particular emphasis on carbon cryogel, are extensively researched as sulfur hosts in Li—S batteries to tackle these issues. Yet, previous carbon host materials suffer from limited pore volume, low proportion of mesopores, and reduced surface area, thereby constraining their capability to accommodate sufficient sulfur.

Resorcinol-formaldehyde (RF) carbon cryogel have been frequently employed in Li—S batteries owing to their high surface area and porosity. However, the RF system's cost-intensiveness restricts the scalability of the process. As such, there is a clear demand for a more economical and scalable method for producing high-performance carbon cryogel.

The current technology provides a method for fabricating carbon cryogel exhibiting high surface area, an increased mesopore ratio, and cost-efficiency, utilizing biomass-derived, low-cost tannin and formaldehyde. Furthermore, this method incorporates calcium salt as a catalyst, a deviation from the widely used sodium carbonate. The resulting carbon cryogel possesses high surface area, an enhanced mesopore ratio, and improved sulfur loading capacity, rendering them ideal sulfur hosts for Li—S batteries. The present method disclosed herein constitutes a significant improvement over the existing state-of-the-art carbon cryogel for Li—S batteries, with potential implications for the progression of high-performance, cost-effective Li—S batteries.

The lithium polysulfide shuttle poses a significant obstacle, limiting the cycling stability and capacity of Li—S batteries. During the cycling process, sulfur species dissolve into the electrolyte, forming highly soluble lithium polysulfides (Li₂Sₓ, where x is typically between 4 and 8) that migrate to the anode and react with lithium, leading to capacity loss and degradation of battery performance.

Catalyst nanoparticles such as metal, metal oxide, sulfide and nitride have emerged as promising solutions for curbing the polysulfide shuttle. However, a uniform distribution of metal nanoparticles within the porous carbon host materials is critical for their effectiveness.

The conventional approach to catalyst loading onto porous carbon often results in non-uniform catalyst distribution, which can compromise the material's performance. Non-uniform distribution can lead to catalyst concentration in certain areas, leaving other regions under-utilized, resulting in sub-optimal catalyst usage and reduced overall process efficacy.

The present technology confronts this challenge with a new approach to incorporate the catalyst into the porous carbon material. In this method, a catalyst, specifically calcium salt, is integrated during the sol-gel synthesis of the carbon cryogel. The catalyst isn't merely loaded onto the carbon material's surface but is embedded within the porous structure during the cryogel's formation.

This integrated approach allows for a more uniform catalyst distribution within the carbon cryogel, ensuring efficient catalyst usage and enhancing the performance of the final material. This innovative process holds substantial potential in applications such as energy storage in lithium-sulfur batteries, where a uniform catalyst distribution can markedly enhance battery performance and lifespan. The present technology relates to the field of energy storage materials and, more specifically, to the fabrication of catalyst-embedded mesoporous carbon cryogels for use as sulfur host materials in lithium-sulfur (Li—S) batteries.

The technical field of this technology encompasses the development of innovative methods for producing carbon cryogels with improved porosity and sulfur loading capacity, which are critical factors for enhancing the performance of Li—S batteries. The technology utilizes biomass-derived polyphenolic precursors, crosslinking agents, and catalysts to create a unique carbon cryogel structure capable of efficiently hosting sulfur and mitigating the polysulfide shuttle phenomenon. The uniform embedding of catalyst nanoparticles within the porous carbon matrix further contributes to the improved battery performance.

The technical field of this technology also extends to the application of Catalyst-Embedded Mesoporous Carbon Cryogels as sulfur hosts in various energy storage devices, including but not limited to Li—S batteries and catalyst host materials for fuel cells.

The present technology addresses the challenges associated with limited pore volume, low proportion of mesopores, and reduced surface area in current carbon host materials, the present technology introduces a novel method for preparing catalyst-embedded mesoporous carbon cryogels with enhanced sulfur loading capacity and improved performance in Li—S batteries. In one example, this method involves the incorporation of calcium nitrate as a catalyst during the sol-gel synthesis process, followed by carbonization and activation in the presence of CO₂ gas. As a result, the activated carbon cryogel exhibits a uniform distribution of nanosized calcium oxide particles, offering an effective solution to mitigate the lithium polysulfide shuttle phenomenon and significantly enhancing the overall performance of Li—S batteries.

The development of low-cost carbon cryogels as hosts for sulfur in Li—S batteries presents a promising solution to overcome the limitations of traditional Li—S battery systems. The present technology addresses critical challenges in the field, including the cost-effectiveness and scalability of the synthesis process, as well as achieving a uniform distribution of catalyst. By disclosing a novel method for fabricating Catalyst-Embedded Mesoporous Carbon Cryogels with enhanced properties, the present technology propels the advancement of high-performance and cost-effective Li—S batteries.

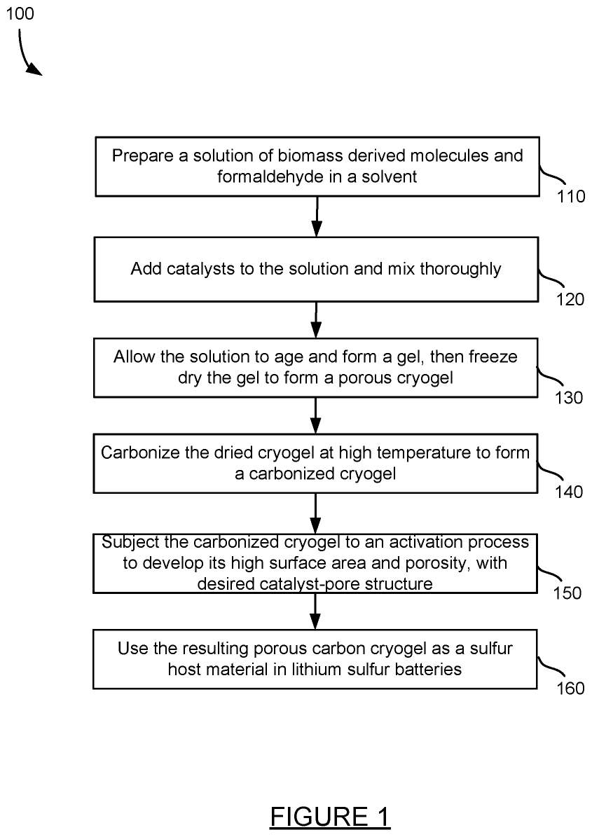

FIG. 1 is a method for preparing host materials. The method 100 of FIG. 1 begins with preparing a solution of biomass derived molecules and formaldehyde in a solvent at step 110. Next, catalysts are added to the solution and mixed thoroughly at step 115. The solution is allowed to age and form a gel, and then the gel is frozen and freeze dried to form a porous cryogel at step 120. The dried cryogel is then carbonized at a high temperature to form a carbonized gel at step 125. The carbonized cryogel is then subjected to an activation process to develop its high surface area and porosity, with desired catalyst-pore structure, at step 130. The resulting porous carbon cryogel can then be used as a sulfur host material in lithium sulfur batteries at step 135.

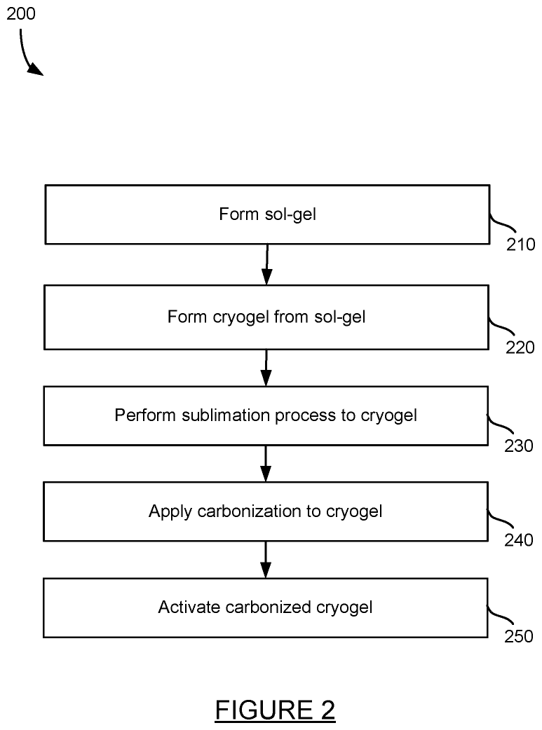

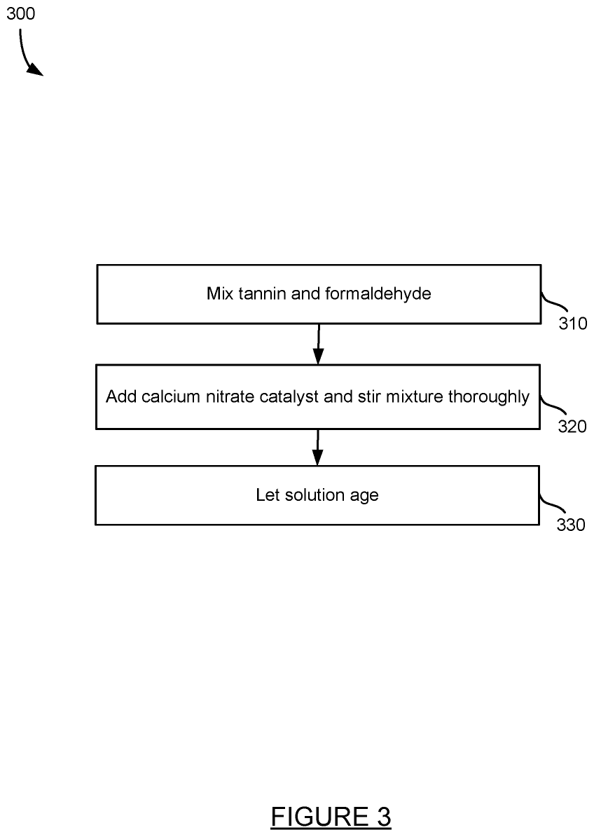

In some instances, the present method for fabricating carbon cryogel host materials for sulfur in Li—S batteries includes multiple stages. FIG. 2 illustrates a method for fabricating a carbon cryogel host material for sulfur in Li—S batteries. Method 200 of FIG. 2 begins with forming a sol-gel at step 210. Forming a sol gel is discussed in more detail with respect to method 300 of FIG. 3. Method 300 for forming a sol-gel begins with mixing tannin and formaldehyde at step 310. Calcium nitrate is added to act as a catalyst and the mixture is stirred until a homogeneous solution is obtained at step 320. The solution is then left to age at step 330. Aging can occur, in some instances, at room temperature, typically for a period of about 24 hours. During this aging process, gelation occurs, converting the sol into a gel.

Returning to FIG. 2, a cryogel is formed from the sol-gel at step 220. The sol-gel is frozen at a low temperature, for example around −80° C. This rapid freezing process promotes the formation of ice crystals throughout the gel, which creates a network of channels in the material.

The frozen gel is then subjected to a sublimation process under vacuum conditions to remove the solvent and create a solid cryogel structure at step 230. This step can be achieved through freeze-drying, which involves the direct conversion of the frozen solvent from solid ice to gas, bypassing the liquid phase. By utilizing freeze-drying, the porosity and structure of the frozen gel are preserved during the removal of the solvent, resulting in a solid cryogel with maintained porosity.

Once the gel is freeze-dried, it is subjected to a carbonization process at step 240. The carbonization process can be achieved under an inert gas atmosphere. Carbonization stabilizes the organic structure and imparts carbon properties to the cryogel. The carbonization can be performed at a high temperature, such as 850° C., to guarantee the decomposition of the organic matrix and its transformation into a carbon framework. Simultaneously, this process facilitates the decomposition of the sol-gel catalyst salt and its conversion into respective calcium and calcium oxide.

The carbonized cryogel undergoes an activation process at step 250. The activation can occur in the presence of CO₂ gas. During this activation process, the calcium or calcium oxide within the cryogel serves as a gasification catalyst for the carbon-CO₂ reaction. This reaction promotes the creation of additional mesopores inside the carbon cryogel, specifically around the calcium nanoparticles. This step typically lasts for about 0.5-2 hours and further enhances the surface area and porosity of the cryogel, which directly improves the sulfur loading capacity.

The activated carbon cryogel contains nanosized calcium oxide particles that are uniformly distributed and embedded within its structure, specifically within the pores of the activated carbon cryogel. With a high specific surface area and a mesopore diameter between 2 and 50 nanometers, this carbon cryogel can host a substantial amount of sulfur for use in Li—S battery cathodes. Additionally, the carbon cryogel can have macropores with diameters between 50 and 300 nanometers. The mesopsore diameter range and macropore diameter range provide a well-defined pore structure for efficient sulfur utilization.

The use of calcium nitrate as a catalyst during the sol-gel synthesis, and the subsequent carbonization and activation in CO₂ gas, enables the creation of a catalyst-embedded mesoporous carbon cryogel host with uniformly embedded nanosized calcium oxide particles. This composition effectively manages the lithium polysulfide shuttle phenomenon in lithium-sulfur batteries, resulting in improved battery performance with enhanced capacity and cycling stability.

In some instances, the activated carbon cryogel exhibits several features that exceed those of prior materials. For example, the activated carbon cryogel exhibits a specific surface area between 300 to 1500 m²/g, and a total pore volume between 0.3 to 3.0 cubic centimeters/gram, which facilitates high sulfur loading and enhancing electrochemical reactions. The activated carbon cryogel also exhibits a catalyst loading between 0.1 to 10 wt. %, ensuring optimal nanoparticle incorporation for effective lithium polysulfide inhibition. In some instances, the catalyst loading is between two to five wt. %.

In some instances, catalyst nanoparticles are uniformly embedded and distributed within the activated carbon cryogel. The uniform distribution of the catalyst nanoparticles within the carbon cryogel pores enhance the performance of the lithium sulfur battery.

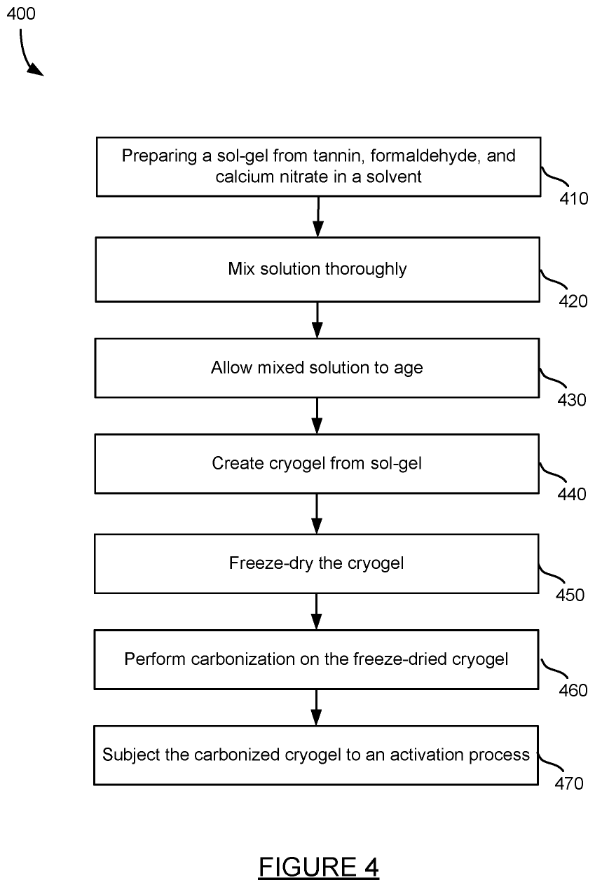

FIG. 4 illustrates a method for fabricating catalyst-embedded mesoporous carbon cryogel as sulfur host materials for lithium-sulfur (Li—S) batteries. These carbon cryogel exhibit improved sulfur loading capacity, enhanced cycling stability, and enhanced battery performance. The method involves the use of tannin or tannic acid as a low-cost precursor, formaldehyde as a crosslinking agent, and calcium nitrate as a catalyst. The resulting carbon cryogel possesses a three-dimensional porous structure with a high specific surface area and a mesopore diameter ranging between 2 and 50 nanometers.

The method 400 of FIG. 4 begins with the preparation of a sol-gel solution at step 410. Preparing the sol-gel can include combining tannin or tannic acid, formaldehyde, and calcium nitrate and sodium carbonate in a suitable solvent. The calcium nitrate and sodium carbonate serve as catalysts, promoting fast gelation during the subsequent aging process. The sol-gel solution is thoroughly mixed at step 430. The solution is mixed to ensure homogeneity, and then left to age at step 430. The solution can be aged at room temperature for a specified period, typically around 24 hours. This aging period allows for gelation to occur, resulting in the formation of a solid gel structure.

The gel is then subjected to a freezing process to create a cryogel at step 440. Freezing is achieved by placing the gel in a low-temperature environment, typically at around −80° C. The rapid freezing process induces the formation of ice crystals throughout the gel, generating a network of interconnected pores.

Next, the frozen organic cryogel goes through a controlled freeze-drying process at step 450. The freeze drying process removes the solvent from the cryogel, but without collapsing its porous structure.

The cryogel undergoes carbonization at step 460. The carbonization converts the organic gel into a carbon framework. Carbonization is carried out in an inert gas atmosphere, such as argon or nitrogen, at a high temperature, typically around 850° C. The carbonization process thermally decomposes the organic components of the cryogel, resulting in the formation of a stable carbon structure while preserving the three-dimensional porous network, with metal oxide uniformly embedded into the porous network.

The carbon cryogel is subjected to an activation step at step 470. The activation can include exposing the cryogel to water steam gas. During activation, the carbon cryogel is exposed to high temperature water steam gas at a high temperature, typically maintained around 750 to 825° C., for a specified period, typically around 1-2 hours. This activation process serves multiple purposes. Firstly, it removes any remaining volatile components from the carbon cryogel, resulting in a more stable structure. Additionally, the activation process enhances the surface area and porosity of the carbon cryogel by creating additional mesopores.

During the water stream activation step, calcium or calcium oxide nanoparticles embedded within the carbon cryogel act as catalytic gasification agents. The calcium or calcium oxide particles promote the reaction between carbon and water steam, leading to the creation of more mesopores inside the carbon cryogel structure, as well as around the calcium nanoparticles. This further increases the surface area, pore volume, and sulfur loading capacity of the activated carbon cryogel.

The resulting activated carbon cryogel exhibits a uniform distribution of nanosized calcium oxide particles embedded within the carbon structure. The presence of these calcium oxide particles provides a high adsorption capability for lithium polysulfides, effectively reducing their migration and concentration in the electrolyte during battery cycling. Additionally, the uniform distribution of the calcium oxide particles throughout the carbon cryogel ensures efficient utilization of the catalyst and enhances the electrochemical reactions within the battery.

The activated carbon cryogel with embedded calcium oxide nanoparticles can be used as a host material for sulfur in Li—S batteries. In the battery assembly, the activated carbon cryogel is typically combined with a lithium or lithium alloy anode, a separator, and an electrolyte to form a complete Li—S battery. The resulting Li—S battery demonstrates improved specific capacity, enhanced cycling stability, and extended battery lifespan.

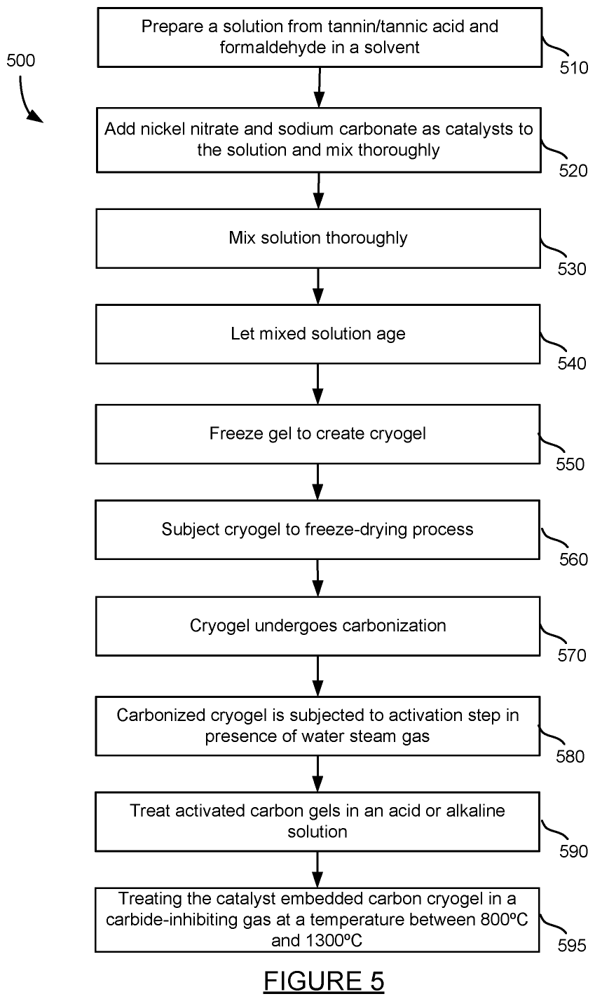

FIG. 5 illustrates a method 500 for fabricating a nickel oxide embedded mesopourous carbon cryogel. The method 500 begins with the preparation of a sol-gel solution by combining tannin or tannic acid and formaldehyde in a suitable solvent at step 510. Nickel nitrate and sodium carbonate are added as catalysts and the solution is missed thoroughly at step 520 The catalysts are added to promote fast gelation during the subsequent aging process. The sol-gel solution is thoroughly mixed at step 530 to ensure homogeneity, and the mixed solution is left to age at step 540. The solution can be aged at room temperature for a specified period, typically around 24 hours. This aging period allows for gelation to occur, resulting in the formation of a solid gel structure.

The gel is then subjected to a freezing process to create a cryogel at step 550. Freezing is achieved by placing the gel in a low-temperature environment, typically at around −80° C. The rapid freezing process induces the formation of ice crystals throughout the gel, generating a network of interconnected pores. The frozen organic cryogel goes through a controlled freeze-drying process at step 560. The controlled freeze-drying process removes the solvent from the cryogel without collapsing its porous structure.

The cryogel undergoes carbonization to convert the organic gel into a carbon framework at step 570. Carbonization is carried out in an inert gas atmosphere, such as argon or nitrogen, at a high temperature, typically around 850° C. The carbonization process thermally decomposes the organic components of the cryogel, resulting in the formation of a stable carbon structure while preserving the three-dimensional porous network, with metal oxide uniformly embedded into the porous network.

Following carbonization, the carbon cryogel is subjected to an activation step in the presence of water steam gas at step 580. During activation, the carbon cryogel is exposed to high temperature water steam gas at a high temperature, typically maintained around 750 to 825° C., for a specified period, typically around 1-2 hours. This activation process serves multiple purposes. Firstly, it removes any remaining volatile components from the carbon cryogel, resulting in a more stable structure. Additionally, the activation process enhances the surface area and porosity of the carbon cryogel by creating additional mesopores.

During the water stream activation step, nickel or nickel oxide nanoparticles embedded within the carbon cryogel act as catalytic gasification agents. The nickel or nickel oxide particles promote the reaction between carbon and water steam, leading to the creation of more mesopores inside the carbon cryogel structure, as well as around the nickel nanoparticles. This further increases the surface area, pore volume, and sulfur loading capacity of the activated carbon cryogel.

The activated carbon gels are treated in an acid or alkaline solution at step 590. The acid treatment operates to partially remove the catalyst particles. Partially removing the catalyst particles will free up the space occupied by them and increase the pore volume. Thus, the cryogels can host more sulfur, and the resulting carbon-sulfur cathode possesses higher capacity.

The catalyst embedded carbon cryogel is treated in a carbide-inhibiting gas at step 595. The treating in the carbide-inhibiting gas can occur at a temperature between 800° C. to 1300° C.

The resulting activated carbon cryogel exhibits a uniform distribution of nanosized nickel oxide particles embedded within the carbon structure. The presence of these nickel oxide particles provides a high adsorption capability for lithium polysulfides, effectively reducing their migration and concentration in the electrolyte during battery cycling. Additionally, the uniform distribution of the nickel oxide particles throughout the carbon cryogel ensures efficient utilization of the catalyst and enhances the electrochemical reactions within the battery.

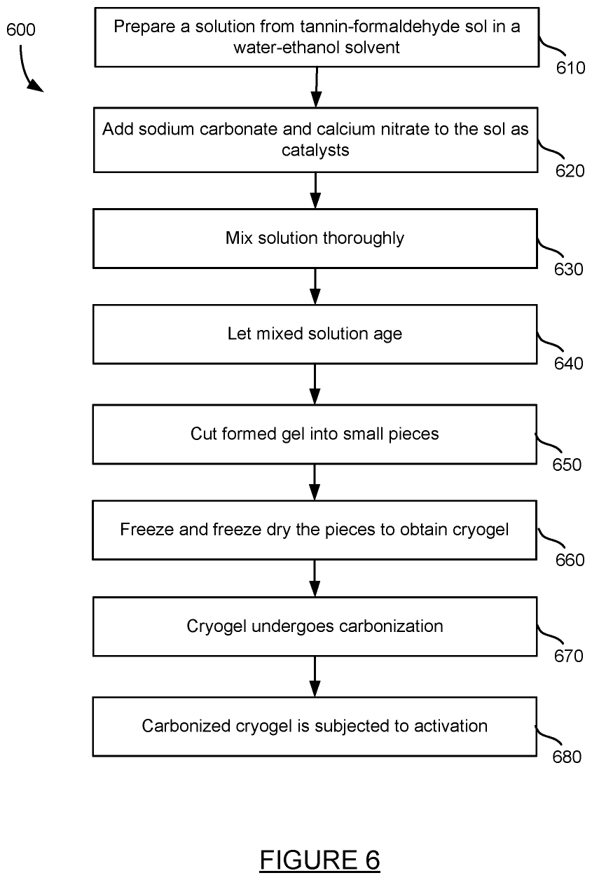

In some instances, sodium carbonate and calcium nitrate can be used as co-catalysts during the tannin-formaldehyde sol-gel process. After freezing, the cryogel can be aged and freeze-dried, carbonized and activated in CO₂. FIG. 6 illustrates a method for fabricating a host material. The method 600 begins with repairing the tannin-formaldehyde sol by dissolving tannin and formaldehyde in water-ethanol solvent at step 610. The ratio of tannin to formaldehyde can be adjusted based on the desired properties of the final product.

Sodium carbonate and calcium nitrate can be added to the sol, with a ratio of 1:1:1 for tannin:sodium carbonate and calcium carbonate, as catalysts, at step 620. The solution can be stirred at step 630 until the co-catalysts are evenly distributed throughout the sol. The mixture can then be aged at step 640 at room temperature for several hours or overnight to allow gelation to occur.

Once the gel has formed, the gel can be removed from the container and cut into small pieces at step 650. The gel pieces are then frozen and freeze-dried at step 660 using a standard freeze-drying protocol to obtain a cryogel.

The cryogel can be carbonized at step 670. Carbonization can include heating the cryogel in a furnace under an inert N₂ gas atmosphere at a temperature of 800-1000° C. for several hours to convert the organic material to carbon. The carbonized cryogel can be activated at step 680. The in CO₂ by heating them in a furnace at a temperature of 600-850° C. for several hours to create a high surface area and porosity. The resulting carbonized and activated cryogel can be used as a host material for a variety of applications, including as a sulfur host material for lithium-sulfur batteries.

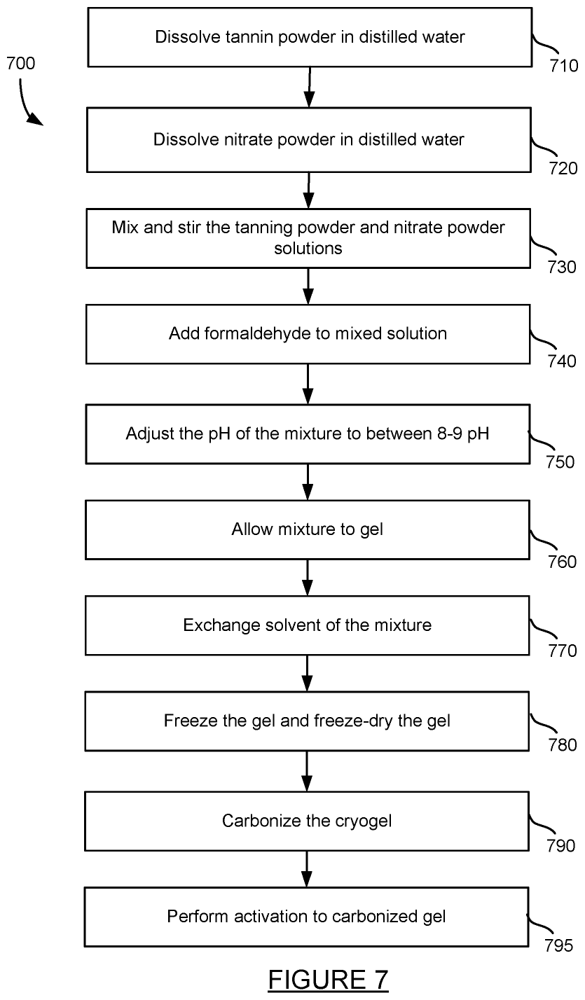

FIG. 7 illustrates a method for preparing a tannin-formaldehyde gel using calcium nitrate as a catalyst and co-solvent of distilled water, methanol and acetone. The method includes a subsequent preparation of activated carbon cryogel with nanosized calcium oxide particles. The method 700 of FIG. 7 beings with dissolving tannin powder in distilled water to make a 10 wt. % solution at step 710. Calcium nitrate powder is dissolved in distilled water in a separate container to make a 2 wt. % solution at step 720. The tannin solution and calcium nitrate solution are mixed and stirred at step 730. The mixtures can be mixed in a 1:1 ratio and stirred for 30 minutes.

A formaldehyde solution can be added dropwise to the combined solution at step 740. The formaldehyde can be added while stirring to obtain a homogeneous mixture. Adjust the pH of the mixture to 8-9 pH at step 750. The pH can be adjusted by adding NaOH solution dropwise while stirring the mixture. The mixture is transferred to a glass container and left to gel at step 760. In some instances, the mixture can gel if the mixture is kept at room temperature for 24 hours.

The solvent of the mixture is exchanged at step 770. In some instances, the water solvent can be exchanged with a methanol and acetone solvent. In some instances, the solvent can be exchanged at least 4 times.

The gel is then frozen and freeze dried at step 780. The gel can be frozen at −80° C. for 24 hours, then freeze-dried for 24 hours to obtain a cryogel. The cryogel is carbonized at step 790. Gel carbonization can be performed in a high-temperature furnace at 850° C. under CO₂ atmosphere for 2 hours to obtain an activated carbon cryogel.

A CO₂ activation is then performed on the carbon cryogel at step 795. The CO₂ activation can be performed for 2 hours at 850° C. The resulting activated carbon cryogel with nanosized calcium oxide particles uniformly embedded inside them can be used as cathode materials for lithium-sulfur batteries.

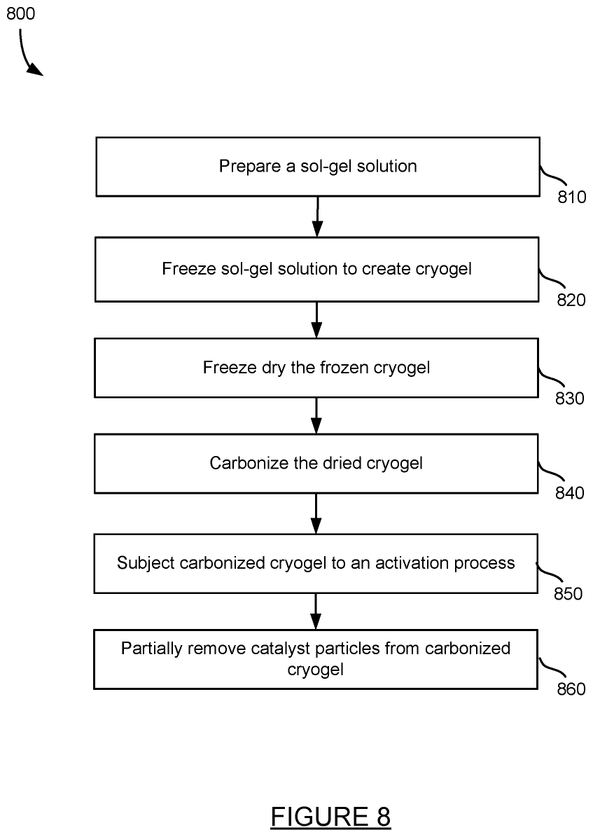

In some instances, tannin-formaldehyde gel can be prepared using nickel nitrate as a catalyst and the activated carbon gels is subjected to acid wash to partially remove the catalyst particles. FIG. 8 illustrates a method 800 for preparing the tannin-formaldehyde gel using a nickel nitrate catalyst and subjecting the gel to an acid wash.

Method 800 begins with preparing a sol-gel solution at step 810. The sol-gel solution can be created by first dissolving tannin or tannic acid in distilled water. For example, 30 grams of tannin or tannic acid can be dissolved in 100 milliliters of distilled water. Next, 15 milliliters of formaldehyde are added, followed by the addition of 45 milligrams of nickel nitrate and 160 milligrams of sodium carbonate. The resulting mixture is then stirred thoroughly until achieving homogeneity. The sol-gel solution is then allowed to age at room temperature for 24 hours, during which gelation occurs, forming a solid gel structure.

The solid gel structure is then frozen to create a cryogel at step 820. The aged gel can be placed in a container suitable for low-temperature conditions and then frozen at approximately −80° C. This rapid freezing process induces the formation of ice crystals throughout the gel, creating a network of interconnected pores. The cryogel is freeze dried at step 830. The frozen gel is subjected to a controlled freeze-drying process to remove the solvent without collapsing the porous structure. The freeze-drying can be carried out until the gel is completely dry.

The dried cryogel undergoes a carbonization process at step 840. The dried cryogel can be placed in a carbonization furnace, and the furnace can be purged with an inert gas atmosphere, specifically argon or nitrogen. The cryogel can be heated in the furnace to approximately 850° C. The carbonization process can be maintained at this temperature, thermally decomposing the organic components and forming a stable carbon structure with uniformly embedded nickel oxide nanoparticles.

The carbonized cryogel can be activated at step 850. The carbonized cryogel can be exposed to water steam gas at a high temperature, maintained between 750° C., for a duration of about 0.5 hours. This activation process removes any remaining volatile components, resulting in a more stable structure and enhancing the surface area and porosity by creating additional mesopores.

The catalyst particles on the carbonized cryogel can be at least partially removed at step 860. The activated carbon cryogel can then be treated in an acid or alkaline solution to partially remove the nickel oxide nanoparticles. For example, the activated carbon cryogel can be immersed in a 0.1 M hydrochloric acid (HCl) solution. This treatment frees up space occupied by the catalyst particles, increasing the pore volume. The treated cryogel is then rinsed with distilled water to remove any residual acid solution and is subsequently dried.

The resulting activated carbon cryogel exhibits a uniform distribution of nanosized nickel oxide particles embedded within the carbon structure. The presence of these nickel oxide particles provides a high adsorption capability for lithium polysulfides, effectively reducing their migration and concentration in the electrolyte during battery cycling. Additionally, the increased pore volume allows for higher sulfur loading, resulting in a carbon-sulfur cathode with higher capacity.

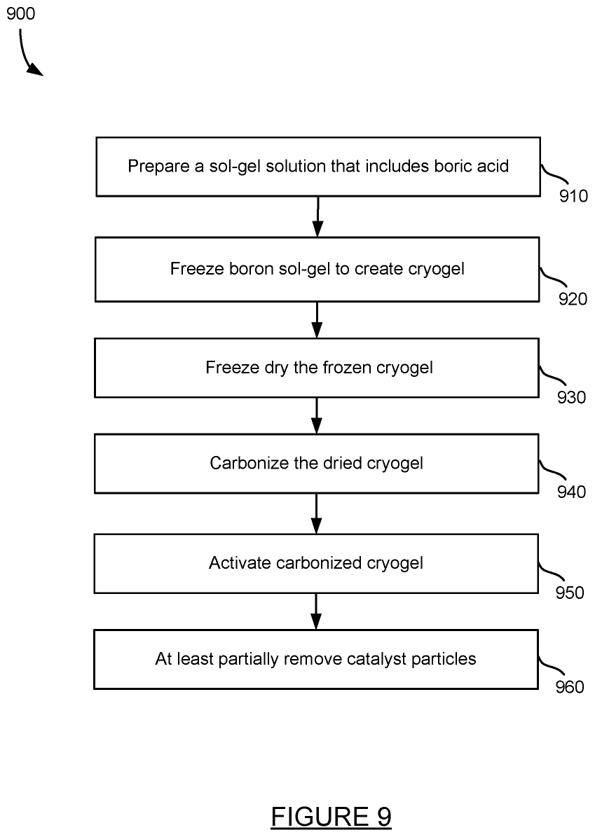

FIG. 9 illustrates a method for preparing a boron-nitrogen co-doped mesoporous carbon cryogel. The method 900 begins with preparation of a boron-nitrogen sol-gel solution at step 910. In some instances, the process involves a sol-gel solution that includes boric acid. For example, in a suitable container, 60 grams of tannin were dissolved in 200 milliliters of distilled water. To this solution, 30 milliliters of formaldehyde were added, followed by the addition of three grams of boric acid (boron compound), two grams of melamine (nitrogen compound), 90 milligrams of nickel nitrate, and 320 milligrams of sodium carbonate. The resulting mixture can be stirred thoroughly until it becomes homogeneous. The sol-gel solution can then age at room temperature, for example for about 24 hours, during which gelation will occur, forming a solid gel structure.

The boron sol-gel can then be frozen to create a cryogel at step 920. The aged sol-gel gel can be placed in a container suitable for low-temperature conditions and then frozen at approximately −80° C. This rapid freezing process will induce the formation of ice crystals throughout the gel, creating a network of interconnected pores.

The frozen cryogel is freeze-dried at step 930. The cryogel can be subjected to a controlled freeze-drying process to remove the solvent without collapsing the porous structure. The freeze-drying can be carried out until the gel is completely dry.

The dried cryogel is carbonized at step 940. Carbonization can include placing the dried cryogel in a carbonization furnace. The furnace can be purged with an inert gas atmosphere, specifically argon or nitrogen, and the cryogel can be heated to approximately 850° C. The carbonization process can be maintained at this temperature, thermally decomposing the organic components and forming a stable carbon structure with uniformly embedded nickel oxide nanoparticles. During this process, boron and nitrogen compounds are integrated into the carbon matrix, forming B—C and N—C bonds.

The carbonized cryogel is activated at step 950. Activation can include exposing the carbonized cryogel to CO₂ gas at a high temperature, maintained at 825° C., for a duration of about 0.5 hours. This activation process removes any remaining volatile components, resulting in a more stable structure and enhancing the surface area and porosity by creating additional mesopores.

Catalyst particles can be at least partially removed at step 960. The activated carbon cryogel can be treated in a 0.1 M hydrochloric acid (HCl) solution to partially remove the nickel oxide nanoparticles. This treatment frees up the space occupied by the catalyst particles, increasing the pore volume. The treated cryogel is then rinsed with distilled water to remove any residual acid and is subsequently dried.

The resulting boron-nitrogen co-doped activated carbon cryogel exhibits a uniform distribution of nanosized nickel oxide particles embedded within the carbon structure. The presence of boron and nitrogen compounds within the carbon matrix provides enhanced electrochemical properties, such as increased electrical conductivity, improved catalytic activity, and higher sulfur loading capacity. The increased pore volume allows for higher sulfur loading, resulting in a carbon-sulfur cathode with higher capacity. Additionally, the boron-nitrogen co-doped carbon cryogel demonstrated improved stability and efficiency in lithium-sulfur batteries by effectively reducing the migration of lithium polysulfides and increasing electrical conductivity.

In some instances, carbon nanotubes (CNTs) can be added to tannin-formaldehyde cryogel to improve their electrochemical properties for use in battery applications. CNTs have high electrical conductivity and can act as a conductive network within the cryogel structure, improving electron transfer during battery cycling.

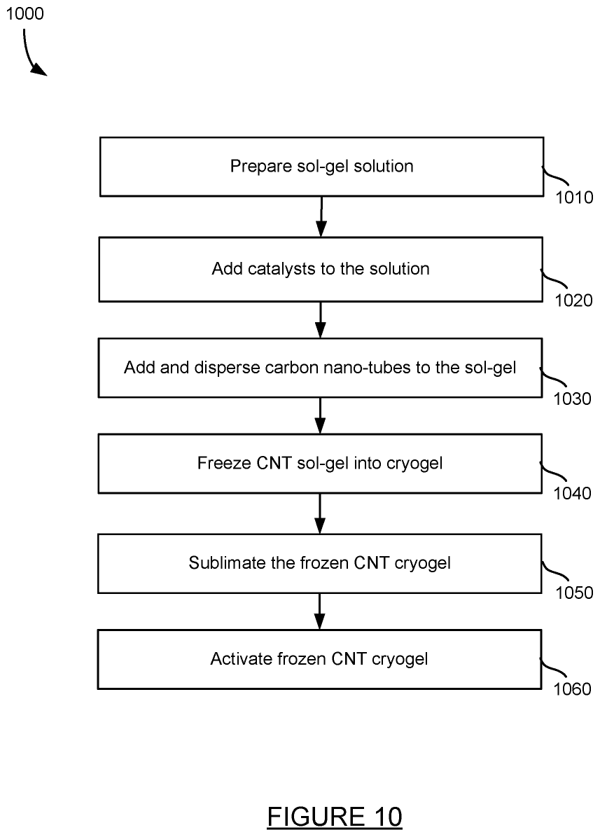

FIG. 10 illustrates a method 1000 for preparing a cryogel with carbon nano-tubes. Method 1000 begins with preparing a sol-gel solution at step 1010. To prepare the sol-gel solution, tannin and formaldehyde precursors can be dissolved in a suitable solvent, such as water or ethanol, to form a sol-gel solution. In some instances, the concentration of the precursors can be adjusted based on the desired properties of the cryogel.

A catalyst, such as sodium carbonate or calcium nitrate, can be added to the sol-gel at step 1020. The catalyst can be added to the sol-gel solution to promote gelation. The catalyst concentration can be optimized for the desired gelation kinetics. In some instances, a surfactant, such as sodium dodecyl sulfate (SDS), can be added to stabilize the sol-gel solution and improve the dispersion of carbon nanotubes.

Carbon nanotubes (CNTs) can be added and dispersed in the sol-gel solution at step 1030. The dispersing can be achieved using sonication or other suitable methods to achieve a uniform distribution of CNTs within the solution.

The concentration of CNTs can be controlled based on the desired loading and properties of the resulting cryogel. The CNT concentration can range from a few weight percent to higher levels depending on the application. The CNT sol-gel can be formed into a gel and then a cryogel at step 1040. The CNT sol-gel can be age at a specific temperature and duration to allow gelation to occur. The aging time can vary from hours to several days.

The sol-gel is then frozen by placing the solution in a freezer or using a freeze-drying technique. In some instances, the freezing temperature can be set below −50° C. The frozen CNT cryogel can be sublimated at setup 1050. The frozen CNT cryogel can be sublimated under vacuum conditions, removing the solvent to create a cryogel structure. In some instances, this can be achieved through freeze-drying or supercritical drying techniques.

The CNT cryogel is activated at step 1060. In some instances, one or more post-treatment steps can be performed, such as for example washing the cryogel with water or an appropriate solvent to remove any residual chemicals or impurities. The cryogel can then be activated by subjecting the cryogel to a high-temperature treatment in an inert atmosphere (e.g., nitrogen or argon) or in the presence of a gas such as CO₂. The activation temperature can range from 500 to 1000° C., depending on the desired properties and application. The resulting tannin-formaldehyde cryogel with carbon nanotubes exhibits enhanced electrochemical properties, including improved electrical conductivity, mechanical strength, and ion transport characteristics.

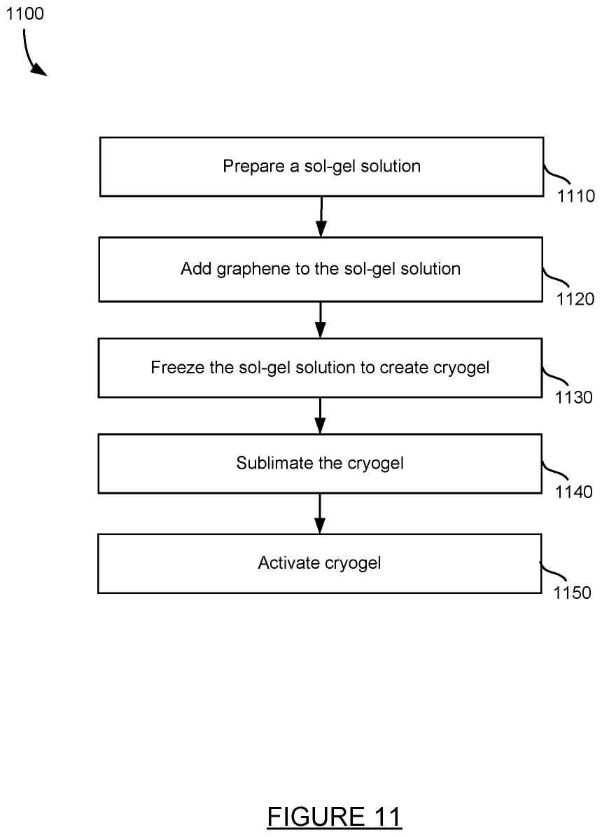

In some instances, the addition of graphene to a tannin-formaldehyde cryogel can potentially improve their mechanical properties and electrical conductivity. FIG. 11 illustrates a method for preparing a cryogel with graphene. Method 1100 of FIG. 11 begins with preparing a sol-gel solution at 1110. Preparing a sol-gel solution can include dissolving tannin and formaldehyde precursors in a suitable solvent, such as water or ethanol, to form a sol-gel solution. The concentration of the precursors can be adjusted based on the desired properties of the cryogel. A catalyst, such as sodium carbonate or calcium nitrate, can be added to the sol-gel solution to promote gelation. The catalyst concentration can be optimized for the desired gelation kinetics. Sodium dodecyl sulfate can be added as surfactant to stabilize the sol-gel solution.

Graphene can be added to the sol-gel at step 1120. In some instances, graphene nanosheets can be dispersed in the sol-gel solution using sonication or other suitable methods. In some instances, excessive sonication or agitation is avoided that might impact the porosity of the resulting cryogel.

The concentration of graphene can be controlled based on the desired loading and properties of the final cryogel. The graphene concentration can be adjusted within a suitable range to achieve the desired properties without compromising porosity. The sol-gel solution can be aged and frozen to create a cryogel at step 1130. The sol-gel solution can be aged at a specific temperature and duration to allow gelation to occur. The aging time can vary from hours to several days, depending on the desired gelation properties. The sol-gel can be frozen by placing the solution in a freezer or using a freeze-drying technique. The freezing temperature can be set at −50° C.

They cryogel can be sublimated at step 1140. Sublimation of the cryogel can be performed under vacuum conditions to remove the solvent, resulting in the formation of a cryogel structure. The cryogel can be activated at step 1150. In some instances, the cryogel can be washed with water or an appropriate solvent to remove any residual chemicals or impurities. The cryogel is then activated by subjecting it to a high-temperature treatment in an inert atmosphere or in the presence of a gas such as CO₂. The activation temperature can range from 500 to 1000° C., depending on the desired properties and application.

The resulting tannin-formaldehyde cryogel with graphene addition exhibits enhanced electrochemical properties while maintaining the desired porosity. The graphene nanosheets contribute to improved electrical conductivity, mechanical strength, and ion transport within the cryogel structure. The final cryogel can be utilized in various applications, particularly in energy storage systems, where the combination of tannin-formaldehyde matrix and graphene offers the potential for high-performance and efficient energy storage.

In some instances, the present technology includes a method to prepare ultrasound assisted lignin-formaldehyde derived carbon cryogel with calcium/sodium carbonate catalyst. Ultrasound-assisted sol-gel synthesis is a technique that involves using high-frequency sound waves to assist in the mixing and reaction of the components in a sol-gel process. In the case of a Lignin-formaldehyde sol-gel process, ultrasound can be used to accelerate the gelation process, reduce the aging time, and enhance solvent exchange.

The ultrasound waves create high-pressure points and low-pressure areas in the solution, which causes the formation and collapse of small bubbles known as cavitation. These bubbles create intense local temperature and pressure changes, which promote the mixing and reaction of the components in the sol-gel process.

The benefits of ultrasound-assisted sol-gel synthesis for lignin-formaldehyde sol-gel process include faster gelation, shorter aging time, and enhanced solvent exchange. The ultrasound waves help to break down the lignin and formaldehyde molecules into smaller particles, which increases their reactivity and promotes the formation of a gel network. This results in a faster gelation process and shorter aging time. Additionally, the ultrasound waves also enhance solvent exchange by creating a more uniform and porous gel network, which allows for better diffusion of solvents and other substances.

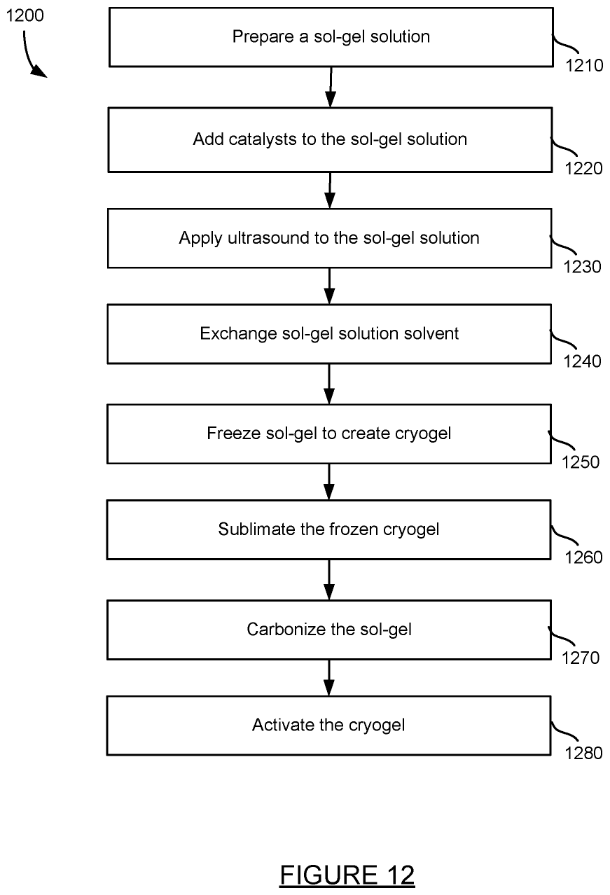

FIG. 12 illustrates a method 1200 for preparing an ultrasound assisted carbon cryogel. The method 1200 begins with preparing a sol-gel solution at step 1210. To prepare the sol-gel solution, lignin and formaldehyde precursors are dissolved in a suitable solvent, such as water or ethanol, to form a sol-gel solution. The concentration of the precursors can be adjusted based on the desired properties of the cryogel.

A catalyst can is added to the sol-gel solution at step 1220. Addition of the catalyst can include adding calcium nitrate or sodium carbonate to the sol-gel solution. The catalyst concentration can be optimized for the desired gelation kinetics.

Ultrasound is applied to the sol-gel solution at step 1230. First, the sol-gel solution should be transferred to a container that is compatible with ultrasound. The container can then be placed in an ultrasound bath. Alternatively, a probe-type ultrasound device can be used to expose the sol-gel solution to high-frequency sound waves. Ultrasound is then applied to the sol-gel solution for a specific duration ranging from a few minutes to several hours, depending on the desired gelation rate. The ultrasound assists in mixing the components and accelerates the gelation process.

The ultrasound processed sol-gel solvent is then exchanged at step 1240. After ultrasound-assisted gelation, the gel can age at a specific temperature and duration to complete the crosslinking and strengthen the gel structure. The aging time can vary depending on the desired properties of the cryogel. The solvent of the sol-gel can then be exchanged. Exchanging the solvent can involve removing the initial solvent and replacing it with a different solvent, through multiple washings. The solvent exchange process helps to remove impurities and residual chemicals.

A cryogel is formed from the sol-gel at step 1250. The aged gel is transferred to a container and frozen by placing the gel mold in a freezer or using a freeze-drying technique. The freezing temperature can be set to −55° C. The frozen cryogel is sublimated at step 1260. The sublimation occurs under vacuum conditions to remove the solvent, resulting in the formation of a cryogel structure.

The cryogel is carbonized at step 1270. Carbonization involves subjecting the cryogel to a high-temperature treatment in an inert atmosphere, typically in a furnace, at temperatures at 900° C. This step removes the remaining organic components and converts the cryogel into carbon. The carbonized cryogel is activated at step 1280. Cryogel activation serves to enhance the porosity and surface area of the carbon cryogel. Activation can be achieved by treating the carbonized cryogel with an activating agent, such as steam or CO₂, at elevated temperatures around 800-900° C.

The resulting ultrasound-assisted lignin-formaldehyde derived carbon cryogel with calcium/sodium carbonate catalyst exhibits improved gelation kinetics, reduced aging time, and enhanced solvent exchange. The ultrasound assistance enables better mixing and accelerates the gelation process, leading to a more efficient synthesis of the cryogel. In some instances, the use of ultrasound-assisted sol-gel synthesis decreases aging and solvent exchange time in the tannin-formaldehyde sol-gel process, stimulates rapid gelation, and diminishes the requirement for prolonged aging and solvent exchange periods.

In some instances, the present technology includes a microwave-assisted sol-gel synthesis for lignin-formaldehyde derived carbon cryogel. Microwave-assisted sol-gel synthesis can accelerate the gelation process of lignin-formaldehyde sol-gel. The mixture of tannin and formaldehyde is exposed to microwave irradiation, which results in the rapid heating of the system and the formation of cross-linked networks.

The benefits of using microwave-assisted sol-gel synthesis for lignin-formaldehyde sol-gel process include fast gelation, reduced aging time, and efficient solvent exchange. The use of microwave irradiation can significantly reduce the time of the generation from several hours to several minutes, leading to a more rapid and efficient process. Additionally, the rapid heating and cross-linking can result in a more homogeneous and well-defined structure of the resulting cryogel.

The use of microwave-assisted sol-gel synthesis also offers benefits in terms of scalability and energy efficiency. The process can be easily scaled up by using larger microwave reactors, which can increase the production rate of the tannin-formaldehyde cryogel. Additionally, the use of microwave irradiation can reduce energy consumption compared to conventional heating methods.

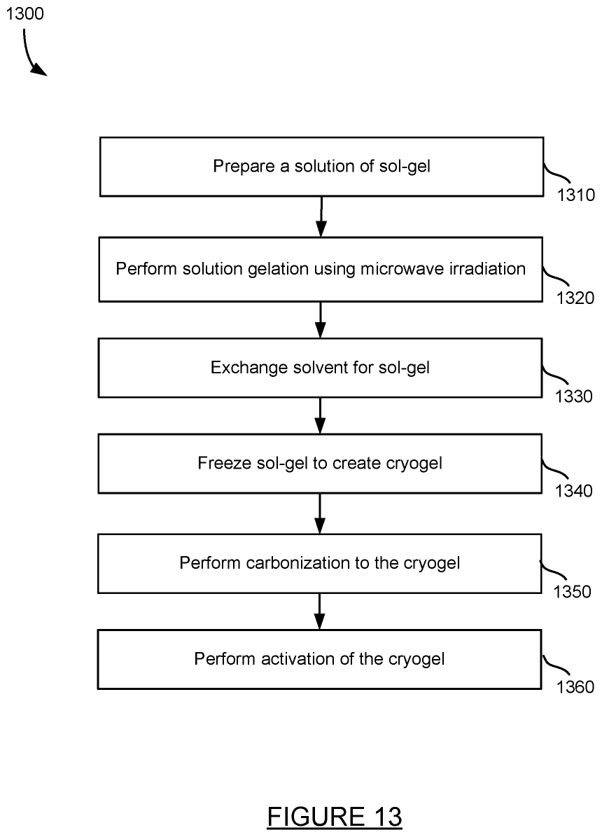

FIG. 13 illustrates a method 1300 for forming a sol-gel using microwave irradiation. The method 1300 begins with preparing the sol-gel solution at step 1310. Preparing the sol-gel mixture beings with combining the appropriate amounts of lignin and formaldehyde precursors in a suitable solvent, such as water or ethanol, to form a sol-gel mixture.

The concentration of the precursors can be adjusted based on the desired properties of the carbon cryogel. Solution gelation using microwave irradiation is performed at step 1320. The sol-gel mixture is transferred to a microwave-safe container, and the container is placed in a microwave reactor that is designed for chemical reactions. Microwave irradiation is applied to the sol-gel mixture for a specific duration, typically ranging from a few minutes to several minutes. The microwave radiation rapidly heats the mixture and promotes the formation of cross-linked networks, accelerating the gelation process.

The microwave processed gel solvent is exchanged at step 1330. The gel can age at a specific temperature for a designated period of time to complete the cross-linking process. The aging time may be shorter compared to conventional methods due to the accelerated gelation achieved through microwave irradiation. The sol-gel solvent can be exchanged to remove the initial solvent and replace it with a different solvent. This process helps eliminate impurities and residual chemicals.

The sol-gel is frozen at step 1340. To freeze the gel, the aged gel can be transferred into a suitable container for freezing, and then frozen. The gel can then be frozen by placing the gel mold in a freezer or using freeze-drying techniques. The freezing temperature can be set to −60° C. In some instances, the frozen gel can be sublimated under vacuum conditions to remove the solvent, resulting in the formation of a cryogel structure. The cryogel is carbonized at step 1350. The cryogel is carbonized by subjecting it to high-temperature treatment in an inert atmosphere, typically in a furnace, at temperatures ranging from 500 to 1000° C. Carbonization removes the remaining organic components and converts the cryogel into carbon. The cryogel is activated at step 1260. The activation can be performed to further enhance the porosity and surface area of the carbon cryogel, using activating agents such as steam or CO₂ at elevated temperatures between 700 to 950° C.

The resulting microwave-assisted lignin-formaldehyde derived carbon cryogel exhibits fast gelation, reduced aging time, efficient solvent exchange, and a well-defined structure. The use of microwave irradiation enables a rapid and efficient synthesis process, leading to improved scalability and energy efficiency. In some instances, use of microwave-assisted sol-gel synthesis curtails aging and solvent exchange time during the tannin-formaldehyde sol-gel process, induces rapid gelation, and lessens the need for extended aging and solvent exchange periods.

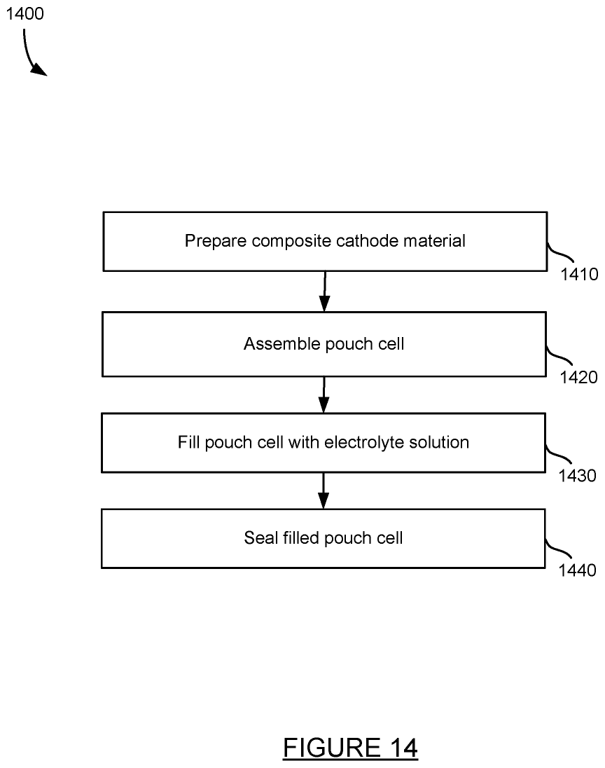

In some instances, preparing a sulfur host includes preparing a composite of sulfur with a catalyst-embedded carbon cryogel host and assembling a pouch cell. FIG. 14 illustrates a method 1400 for forming a composite of sulfur with a cryogel host within a pouch. Method 1400 begins with preparing a composite cathode material at step 1410.

To prepare the composite cathode material, sulfur is melted in a suitable container at an elevated temperature to obtain a liquid sulfur phase. A prepared catalyst-embedded carbon cryogel host is immersed in the liquid sulfur, ensuring complete impregnation of sulfur into the porous structure. The composite is cooled and allowed to solidify, resulting in a sulfur-carbon cryogel composite material.

A pouch cell is assembled at step 1420. Assembly of the pouch cell requires a lithium alloy anode and ceramic coated separator. The lithium allow anode can be an available lithium alloy anode, produced by coating a lithium alloy (e.g., Li metal or Li-metal alloy) onto a current collector substrate. The ceramic-coated separator can be produced by coating a ceramic layer (e.g., ceramic nanoparticles or ceramic membrane) onto a separator material to enhance safety and prevent dendrite formation.

The pouch can be assembled by sandwiching the composite sulfur cathode, lithium alloy anode, and ceramic-coated separator in a suitable configuration. The assembled pouch can be filled at step 1430. The pouch cell can be filled with the electrolyte solution, which is composed of 1M lithium bis(trifluoromethane) sulfonimide (LiTFSI) and 2 wt. % LiNO3 dissolved in a mixture of DOL (1,3-dioxolane) and DME (1,2-dimethoxyethane) in a 1:1 volume ratio.

The filled pouch can be sealed at step 1440. The pouch cell is sealed to prevent leakage or moisture ingress.

The resulting pouch cell with the composite sulfur cathode, lithium alloy anode, ceramic-coated separator, and the specified electrolyte composition exhibits improved capacity and cycling stability, making it suitable for high-performance lithium-sulfur battery applications.

In some instances, to use lignin instead of tannin in the sulfur host formation process, the process requires additional optimization to achieve the desired properties of the carbon cryogel as a host material for sulfur in lithium-sulfur batteries.

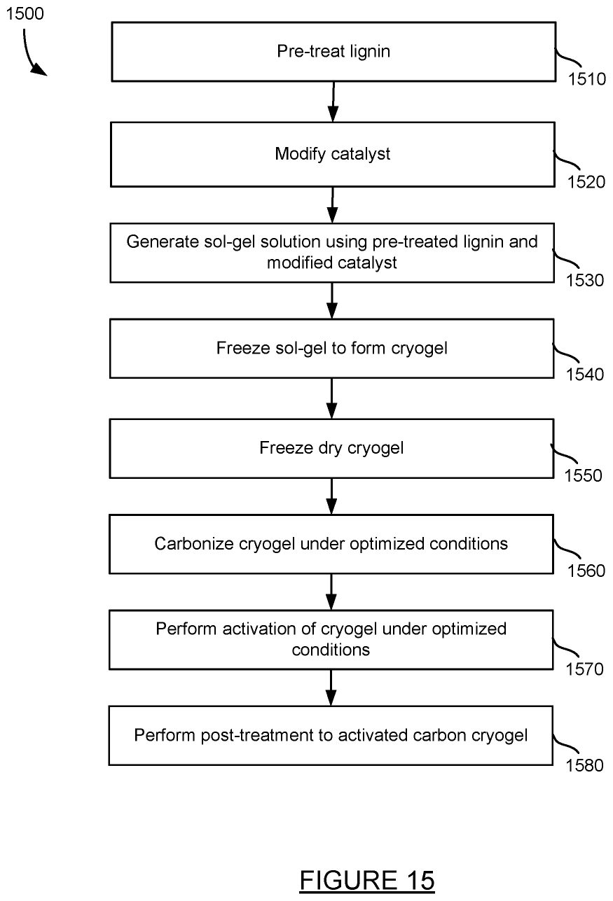

In some instances, carbonized cryogel formation process provides for an improved lignin-formaldehyde derived calcium oxide containing activated carbon cryogel. FIG. 15 illustrates a method 1500 for providing an improved carbon cryogel. Method 1500 begins with pre-treating lignin at step 1510. Lignin can be pretreated to modify its chemical and physical properties. For example, lignin can be dissolved in a solvent or treated with an acid or base to break down its complex structure and increase its solubility in water. This can help to achieve a more uniform distribution of lignin in the gel and ultimately result in a more uniform distribution of calcium oxide in the carbon cryogel.

A catalyst can be modified at step 1520. The type and concentration of catalyst used in the synthesis process can be modified to improve the uniformity of the resulting carbon cryogel. For example, a mixture of calcium nitrate and sodium carbonate may be used as catalyst to improve the solubility of lignin and enhance the cross-linking reaction. Additionally, the concentration of the catalyst can be optimized to achieve a more uniform distribution of calcium oxide in the carbon cryogel.

A sol gel solution can be generated using the modified lignin, modified catalyst, and other components in a solvent at step 1530. The solvent can be aged to form a gel, and then frozen to form a cryogel at step 1540. The cryogel can, in some instances, be freeze dried at step 1550.

The carbonization and activation conditions can be optimized. Carbonization and activation optimizations can be performed to achieve a high surface area and mesopore ratio. The temperature, time, and gas flow rate can be adjusted to create a more porous structure in the carbon cryogel. For example, a higher temperature and longer activation time can create more mesopores in the carbon cryogel.

The cryogel can be carbonized under optimized conditions at step 1560. The carbonized cryogel can then be activated under optimized conditions at step 1570. The carbon cryogel can be post-treated at step 1580. Carbon cryogel post-treatment can be used to modify its properties. For example, carbon cryogel can be treated with a surfactant or acid to further increase its surface area and mesopore ratio. Additionally, a treatment with calcium acetate or other calcium-containing solution may be used to further increase the amount of calcium oxide embedded in the carbon cryogel. In some instances, any, all, or none of the modifications and/or optimizations discussed with respect to steps 1510-1580 can be performed to modify and optimize the formation process of a carbonized and activated cryogel.

These changes improve the uniformity of calcium oxide inside the lignin-formaldehyde derived carbon cryogel, as well as increase the surface area and mesopore ratio of the final product. In some instances, Biomass-derived Polyphenolic Precursors used in the method are obtained from natural sources such as tannin, lignin, or other similar plant-based materials. In some instances, the polyphenolic precursors are extracted from one or more of bark, wood, nutshells, and plant residues. This emphasizes the use of renewable and sustainable precursors in the fabrication of the Catalyst-Embedded Mesoporous Carbon Cryogel, aligning with the growing demand for eco-friendly and green technologies. In some instances, the polyphenolic precursors are chemically modified to enhance their reactivity and suitability for the sol-gel process. The polyphenolic precursors are mixed with a suitable solvent to form the sol-gel solution, further enhancing their compatibility and processing characteristics.

In some instances, regarding the crosslinking agent used in the method, incorporating biomass-derived alternatives such as furfural and specifying the inclusion of a catalyst in the crosslinking agent mixture. The crosslinking agent can include formaldehyde and a biomass-derived crosslinking agent, selected from the group consisting of furfural, levulinic acid, glyoxal, and their derivatives.

In some instances, the catalyst added to the aqueous solution to promote the sol-gel reaction and form a crosslinked gel network is selected from the group consisting of group consisting of sodium carbonate, calcium carbonate, calcium nitrate, ammonium hydroxide, boron trifluoride etherate, boric acid, zinc chloride, magnesium oxide, tetramethylammonium hydroxide, titanium oxide, cobalt sulfide, nickel nitrate, iron nitrate and molybdenum nitride. In some instances, the catalyst comprises calcium nitrate, which undergoes conversion into calcium oxide during the carbonization step and serves as a carbon gasification catalyst in the activation step. In some instances, the catalyst comprises nickel nitrate, which undergoes conversion into nickel oxide during the carbonization step and serves as a carbon gasification catalyst in the activation step. In some instances, the catalyst comprises iron nitrate, which undergoes conversion into iron oxide during the carbonization step and serves as a carbon gasification catalyst in the activation step.

In some instances, the catalyst further comprises a combination of calcium nitrate and sodium carbonate, which synergistically promote gelation and crosslinking of the biomass-derived polyphenolic precursors, resulting in a catalyst-embedded mesoporous carbon cryogel with superior porosity and sulfur utilization. In some instances, catalyst nanoparticles embedded within the carbon cryogel structure have a particle diameter ranging from 1 to 100 nanometers.

In some instances, the catalyst includes boron trifluoride etherate, a Lewis acid catalyst that promotes the formation of a rigid and dense gel network, the boron trifluoride etherate enhancing the interaction between the host materials and polysulfide, contributing to improved performance and stability in lithium-sulfur batteries. In some instances, the catalyst comprises tetramethylammonium hydroxide, which serves as a quaternary ammonium salt catalyst and surfactant, promoting the sol-gel reaction and facilitating the formation of porous materials with well-defined pore structures. In some instances, wherein the catalyst comprises a combination of magnesium oxide and zinc chloride, which act as Lewis acid catalysts, promoting gelation and crosslinking of the biomass-derived polyphenolic precursors and resulting in an activated carbon cryogel with excellent mesopore distribution and sulfur loading capacity. In some instances, catalyst nanoparticles embedded within the cryogel structure include, but not limited to calcium oxide, manganese oxide, titanium oxide, cerium oxide, nickel oxide, iron oxide, as well as their corresponding nitride and sulfide counterparts.

In some instances, the catalyst nanoparticles embedded within the carbon cryogel can be used as catalyst supports, gas storage systems, soil remediation, and insulation.

In some instances, different catalyst options can be employed in the method for producing the Catalyst-Embedded Mesoporous Carbon Cryogel. The different catalyst options emphasize the importance of catalyst selection and their uniform distribution within the carbon cryogel, leading to improved porosity, sulfur loading capacity, and overall battery performance.

In some instances, a carbonized cryogel can be activated in the presence of an oxidative gas, such as for example CO₂, water steam, ozone, or combination of these gases.

In some instances, the activated carbon cryogel can be treated in an acidic or alkaline solution to partially remove the catalyst particles, thereby increasing the pore volume of the activated carbon cryogel, and the treated cryogel can be rinsed with distilled water to remove any residual acid or alkaline. The cryogel can then be dried.

In some instances, the catalyst-embedded carbon cryogel can be treated in a carbide-inhibiting gas at a temperature between 800° C. and 1300° C. to increase its electric conductivity. The carbide-inhibiting agent operates to minimize the formation of metal carbides. In some instances, the carbide-inhibiting agent can include nitrogen, ammonia gas, or a boron-containing gas such as diborane or boron trifluoride.

In some instances, the nanoparticles are uniformly distributed and embedded within the pores of the activated carbon cryogel and have a diameter between 2 nm to 100 nm.

In some instances, a activated carbon cryogel has a nanoparticle loading capacity ranging from 0.1 to 10 wt. %, and a diameter between 2 nm to 100 nm.

In some instances, the inclusion of a surfactant in the sol-gel solution is used to prepare the Catalyst-Embedded Mesoporous Carbon Cryogel. The surfactant aids in stabilizing the gel and promoting rapid gelation, leading to improved porosity and sulfur loading capacity. Examples of suitable surfactants include F127, SDS, CTAB, and their derivatives.

The solvent used to formulate and/or generate the sol-gel can be one or more of water, ethanol, methanol, acetone, and their mixtures. In some instances, a co-solvent can be added to the sol-gel solution, wherein the co-solvent is miscible with the solvent and the non-solvent, thereby increasing the solubility of the biomass-derived polyphenolic precursors and accelerating the gelation process. The co-solvent can include one or more of, or a combination of, dimethyl sulfoxide (DMSO), N,N-dimethylformamide (DMF), tetrahydrofuran (THF), and their mixtures.

In some instances, the activated carbon cryogel is doped with boron and/or nitrogen compounds, resulting in a boron-doped, nitrogen-doped, and/or boron-nitrogen co-doped carbon structure. The boron and nitrogen compounds remain integrated within the carbon matrix after carbonization and activation, forming stable B—C and N—C bonds. This doping provides enhanced electrochemical properties, including increased electrical conductivity, improved catalytic activity, and higher sulfur loading capacity.

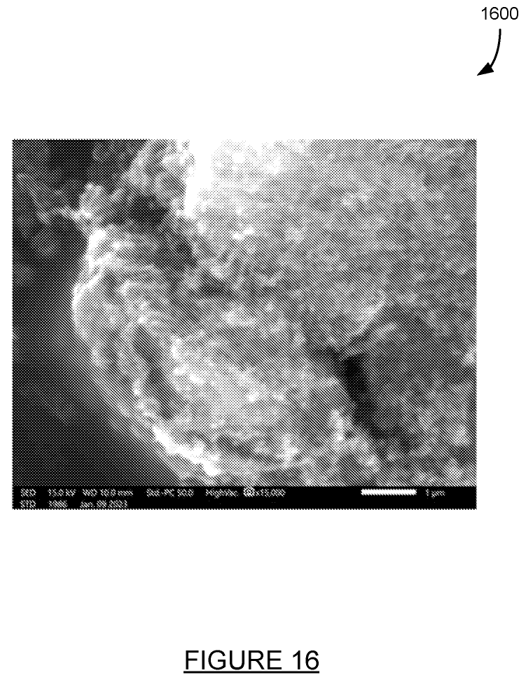

FIG. 16 illustrates an SEM image of metal oxide doped mesoporous carbon. The image 1600 of FIG. 16 illustrates metal oxide doped mesoporous carbon over a distance of approximately 10 micrometers (μm).

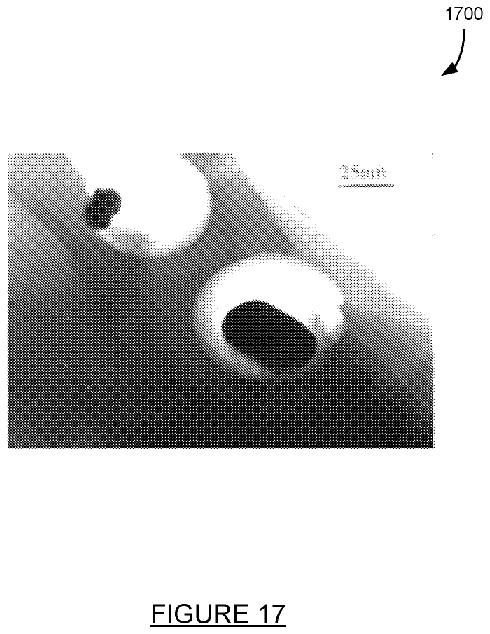

FIG. 17 illustrates a TEM image of metal oxide doped mesoporous carbon. The image 1700 of FIG. 17 illustrates a surface over a distance of approximately 50 nanometers (nm).

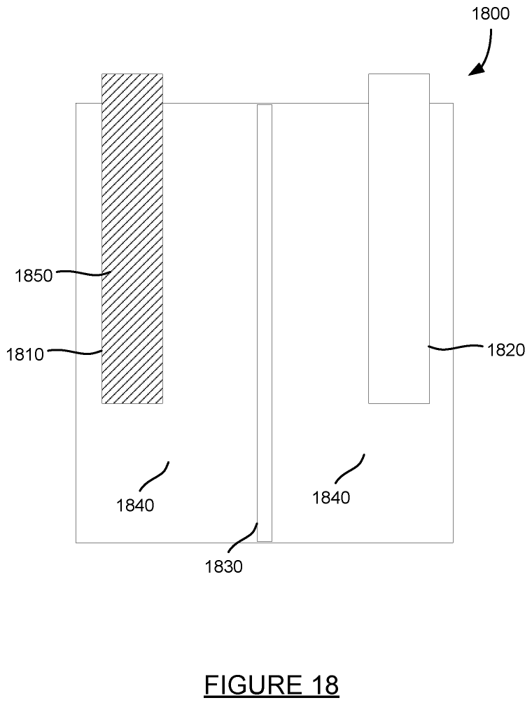

FIG. 18 illustrates a battery cell. Battery cell 1800 of FIG. 18 includes cathode 1810, anode 1820, separator 1830, and electrolyte 1840. The cathode including a sulfur cathode that includes a host material 1850. The host material 1850 can be formed from a catalyst-embedded mesoporous carbon cryogel.

Several terms are used through this disclosure. For example, F127 refers to Pluronic F127, which is a triblock copolymer composed of poly(ethylene oxide)-poly(propylene oxide)-poly(ethylene oxide) (PEO-PPO-PEO). Its full chemical name is poly(ethylene oxide)-block-poly(propylene oxide)-block-poly(ethylene oxide).

SDS stands for sodium dodecyl sulfate, which is a commonly used anionic surfactant. Its chemical name is sodium lauryl sulfate.

CTAB is an abbreviation for cetyltrimethylammonium bromide, which is a cationic surfactant. Its chemical name is cetyltrimethylammonium bromide.

These surfactants are widely used in various scientific and industrial applications for their unique properties in stabilizing colloidal systems and influencing the structure and properties of materials.

In some instances, the complex molecular structure of tannin and lignin makes their reaction with formaldehyde challenging in the process of gel formation. This is primarily due to the presence of various reactive functional groups and the potential formation of multiple reaction products, which can complicate the gelation process.

In some instances, different solvents and co-solvents can be used in the sol-gel solution preparation. In some instances, a co-solvent can be used to enhance solubility and accelerate gelation. Examples of suitable co-solvents can include DMSO, DMF, THE, and their mixtures.

1. A method for producing a catalyst-embedded mesoporous carbon cryogel, comprising:
preparing a sol-gel solution that includes a biomass-derived polyphenolic precursor, a crosslinking agent, a catalyst, and a surfactant in a solvent;
aging the sol-gel solution to form a gel;
freezing the gel to form an organic cryogel;
carbonizing the organic cryogel in the presence of an inert gas to prepare a carbon cryogel having a first number of mesopores; and
activating the carbonized cryogel in the presence of an oxidative gas to prepare an activated carbon cryogel having a second number of mesopores in the carbon cryogel, the second number of mesopores for the activated carbon cryogel being larger than the first number of mesopores in the carbonized cryogel.

2. The method of claim 1, further comprising freeze-drying the gel to form the organic cryogel.

3. The method of claim 1, wherein the oxidative gas includes CO₂, water steam, ozone, or combinations thereof.

4. The method of claim 1, further comprising:
treating the activated carbon cryogel in an acidic or alkaline solution to partially remove the catalyst particles, thereby increasing the pore volume of the activated carbon cryogel;
rinsing the treated cryogel with distilled water to remove any residual acid or alkaline; and
subsequently drying the cryogel.

5. The method of claim 1, further comprising treating the catalyst-embedded carbon cryogel in a carbide-inhibiting gas at a temperature between 800° C. and 1300° C. to increase its electric conductivity, with the carbide-inhibiting agent minimizing the formation of metal carbides.

6. The method of claim 1, wherein the activated carbon cryogel possesses mesopores with diameters between 2 and 50 nanometers, and macropores with diameters between 50 and 300 nanometers.

7. The method of claim 1, wherein the activated carbon cryogel exhibits a specific surface area between 300 to 1500 m²/g, and a total pore volume between 0.3 to 3.0 cc/g.

8. The method of claim 1, wherein nanoparticles are uniformly distributed and embedded within the pores of the activated carbon cryogel, and the nanoparticles have a diameter between 2 nm to 100 nm.

9. The method of claim 1, wherein the activated carbon cryogel exhibits a catalyst loading between 0.1 to 10 wt. %, and preferably within the range of 2 to 5 wt. %.

10. The method of claim 1, wherein the Biomass-derived polyphenolic precursor comprise one or more of tannin and lignin, the one or more of tannin and lignin from renewable biomass sources such as plants or agricultural residues.

11. The method of claim 1, wherein the Biomass-derived polyphenolic precursor are extracted from one or more of bark, wood, nutshells, and plant residues.

12. The method of claim 1, wherein the Biomass-derived polyphenolic precursor are chemically modified to enhance their reactivity and suitability for the sol-gel process.

13. The method of claim 1, wherein the Biomass-derived polyphenolic precursor are mixed with a suitable solvent to form the sol-gel solution, further enhancing their compatibility and processing characteristics.

14. The method of claim 1, wherein aging includes the use of ultrasound-assisted sol-gel synthesis to stimulate rapid gelation.

15. The method of claim 1, wherein aging includes the user of microwave irradiation to induce faster radiation.

16. The method of claim 1, wherein the crosslinking agent comprises formaldehyde and a biomass-derived crosslinking agent, selected from the group consisting of furfural, levulinic acid, glyoxal, and their derivatives.

17. The method of claim 1, wherein the biomass-derived crosslinking agent is furfural.

18. The method of claim 1, wherein the catalyst added to the aqueous solution to promote the sol-gel reaction and form a crosslinked gel network is selected from the group consisting of group consisting of sodium carbonate, calcium carbonate, calcium nitrate, ammonium hydroxide, boron trifluoride etherate, boric acid, zinc chloride, magnesium oxide, tetramethylammonium hydroxide, titanium oxide, cobalt sulfide, nickel nitrate, iron nitrate and molybdenum nitride.

19. The method of claim 1, wherein the catalyst comprises calcium nitrate, which undergoes conversion into calcium oxide during the carbonization step and serves as a carbon gasification catalyst in the activation step.

20. The method of claim 1, wherein the catalyst comprises nickel nitrate, which undergoes conversion into nickel oxide during the carbonization step and serves as a carbon gasification catalyst in the activation step.

21. The method of claim 1, wherein the catalyst comprises iron nitrate, which undergoes conversion into iron oxide during the carbonization step and serves as a carbon gasification catalyst in the activation step.

22. The method of claim 14, wherein the catalyst conversion creates mesopores surrounding the catalyst particles within the carbon cryogel.

23. The method of claim 14, wherein the catalyst particles are uniformly distributed and embedded within the activated carbon cryogel.

24. The method of claim 1, wherein the catalyst further comprises a combination of calcium nitrate and sodium carbonate, which synergistically promote gelation and crosslinking of the biomass-derived polyphenolic precursor.

25. The method of claim 1, wherein the catalyst includes boron trifluoride etherate.

26. The method of claim 1, wherein the catalyst comprises tetramethylammonium hydroxide, which serves as a quaternary ammonium salt catalyst and surfactant.

27. The method of claim 1, wherein the catalyst comprises a combination of magnesium oxide and zinc chloride, which acts as Lewis acid catalysts, promoting gelation and crosslinking of the biomass-derived polyphenolic precursor and resulting in an activated carbon cryogel.

28. The method of claim 1, wherein the surfactant included in the sol-gel solution is selected from the group consisting of F127, SDS, CTAB, and their derivatives, wherein the surfactant aids in stabilizing the gel and promoting rapid gelation.

29. The method of claim 1, wherein the solvent used in the sol-gel solution is selected from the group consisting of water, ethanol, methanol, acetone, and their mixtures.

30. The method of claim 1, wherein a co-solvent is added to the sol-gel solution, the co-solvent being miscible with the solvent and the non-solvent, thereby increasing the solubility of the biomass-derived polyphenolic precursor and accelerating the gelation process.

31. The method of claim 1, wherein the co-solvent is selected from the group consisting of dimethyl sulfoxide (DMSO), N,N-dimethylformamide (DMF), tetrahydrofuran (THF), and their mixtures.

32. The method of claim 1, further comprising adding a co-solvent to the sol-gel, wherein the co-solvent is miscible with both the solvent and the biomass-derived polyphenolic precursor, the crosslinking agent, the catalyst, and the surfactant, wherein the co-solvent enhances the solubility of tannin and accelerates the gelation process.

33. The method of claim 1, further comprising integrating the application of a combination of calcium nitrate and sodium carbonate catalysts, wherein the catalyst combination promotes rapid gelation and decreases the need for extended aging and solvent exchange periods.

34. The method of claim 1, further comprising the use of F127 or SDS surfactant to stabilize the gel and foster rapid gelation, thereby reducing the necessity for extended aging and solvent exchange periods.

35. The method of claim 1, wherein the catalyst-embedded mesoporous carbon cryogel forms a sulfur cathode hosting material for high-performance lithium-sulfur batteries and catalyst host materials for efficient fuel cells.

36. The method of claim 1, wherein the carbide-inhibiting agent includes nitrogen or ammonia gas, or boron-containing gas such as diborane or boron trifluoride.

37. A carbon cryogel for use as a sulfur host material, comprising:
a porous carbon material frozen to form an activated carbon cryogel; and
a plurality of catalyst nanoparticles uniformly embedded within the activated carbon cryogel and distributed within the activated carbon cryogel.

38. The carbon cryogel of claim 37, wherein the activated carbon cryogel contains mesopores with diameters ranging between 2 and 50 nanometers and macropores with diameters between 50 and 300 nanometers.

39. The carbon cryogel of claim 37, wherein the activated carbon cryogel exhibits a specific surface area ranging from 300 to 1500 m²/g and a total pore volume ranging from 0.3 to 3.0 cc/g.

40. The carbon cryogel of claim 37, wherein the activated carbon cryogel has a nanoparticle loading capacity ranging from 0.1 to 10 wt. %, and a diameter between 2 nm to 100 nm.

41. The carbon cryogel of claim 37, wherein the catalyst nanoparticles embedded within the cryogel structure include at least one of calcium oxide, manganese oxide, titanium oxide, cerium oxide, nickel oxide, iron oxide, as well as their corresponding nitride and sulfide counterparts.

42. The carbon cryogel of claim 37, wherein the catalyst nanoparticles embedded within the carbon cryogel structure have a particle diameter ranging from 1 to 100 nanometers.

43. The carbon cryogel of claim 37, wherein the catalyst nanoparticles embedded within the carbon cryogel can be used as catalyst supports, gas storage systems, soil remediation, and insulation.

44. The carbon cryogel of claim 37, wherein the activated carbon cryogel is doped with boron and/or nitrogen compounds, resulting in a boron-doped, nitrogen-doped, and/or boron-nitrogen co-doped carbon structure.

45. A battery cell, comprising:
a cathode electrode, the cathode material including a sulfur cathode that includes a host material, the host material formed from a catalyst-embedded mesoporous carbon cryogel;
an anode electrode;
a separator; and
an electrolyte.
